(19) United States
(12) Patent Application Publication
(10) Pub. No.: US 2005/0034819 A1
(43) Pub. Date: Feb. 17, 2005

(54) Device for making containers

(76) Inventors: David C. Brown, Clark Summit, PA (US); Alois A. Schmidtner, Hellertown, PA (US)

Correspondence Address: FINNEGAN, HENDERSON, FARABOW, GARRETT & DUNNER;LLP, 1300 I STREET, NW, WASHINGTON, DC, 20005, US

(21) Appl. No.: 10/869,069

(22) Filed: Jun. 17, 2004

Related U.S. Application Data
(60) Provisional application No. 60/479,219, filed on Jun. 18, 2003.

(51) Int. Cl. B65C 9/00; B31C 1/00; B65H 81/00

(52) U.S. Cl. 156/567; 156/566; 156/184

(57) ABSTRACT

A device for making containers, comprising a paper feeding system configured to feed side blanks, a sleeve-forming unit receiving the slide blanks and forming them into sleeves, a bottom forming unit configured to form bottoms, an indexed container-forming turret for receiving the sleeves and the bottoms and adhering a bottom to each sleeve, and a continuously running mechanism to remove sleeves from the sleeve-forming unit and transfer them to the container-forming turret.

### BACKGROUND OF THE INVENTION

1. Field of the Invention

The present invention relates to a device for making containers and, more particularly, to a device for making paper containers at increased production speeds. Examples of paper containers made by the device include cups and/or cartons of a variety of sizes for containing and/or storing liquids (e.g., beverages) and/or solid products (e.g., frozen substances).

2. Description of the Related Art

Devices for making paper containers are known in the art. Typically in these devices, a side blank is initially formed into a sleeve. The sleeve is then mated with a container bottom and the sleeve and bottom are sealed together. Additional finishing steps are then carried out to form the finished container.

An example of a conventional device 20 is shown in FIG. 1. As shown, the conventional device 20 includes a side paper feeding system 22, a side seam heating system 24, a sleeve-forming unit 26, and an indexed-motion sleeve transfer system 28. The device 20 further includes a bottom paper feeding system 30, a bottom forming unit 32 including a bottom transfer table 34, and a container-forming turret 36. Finally, the device includes a bottom sealing system 38, a container transfer system 40, a top curl system 42, and a container discharge system 44.

The side paper feeding system 22 supplies side blanks to the device. In some devices, the side paper feeding system 22 feeds paper to the device from a paper roll 46. The paper is fed from the roll 46 into a side paper punch 48, which cuts side blanks from the paper.

In an alternative side paper feeding system arrangement partially shown in FIG. 2, a vertical side blank delivery system 50 utilizes pre-cut side blanks 52 stacked in a hopper 54. The side blanks 52 in the vertical delivery system are taken from the bottom of the stack through an opening in the platform 56. Due to constraints in the feed mechanism, the hopper 54 may be loaded with no more than about a 10-inch stack of side blanks at a time.

A plurality of vertical side blank delivery systems 50 could be arranged on a carousel within a housing. In this arrangement, as the side blanks 52 in one hopper are used up, the carousel supplies the device with a full hopper. Similar to when a single hopper is used, each hopper may be loaded with no more than about a 10-inch stack of side blanks.

Regardless of whether the device uses pre-cut blanks or forms the blanks from paper material, the side blanks enter a sealing system, such as a side seam heating system 24. The side seam heating system 24 could comprise a conveyor 58 for moving the side blanks 52 and several heaters arranged above and below the conveyor to heat the side blanks 52. As a side blank 52 passes adjacent to a heater, the respective heater is temporarily operated to expose the edges of the side blank 52 to a burst of hot air. The hot air activates a coating on the paper that is capable of providing subsequent sealing. In one embodiment, the paper is coated with a plastic coating, such as polyethylene, polypropylene, or PEP, that is activated when heated. Other adhesive means such as glue can also be used. When the side blank 52 passes away from a respective heater, the heater is controlled so that there is a pause of hot air flowing from the heater. This cycle is repeated as each side blank moves through the system.

The heated side blanks next enter the sleeve-forming unit 26, which comprises a turret 60 having a plurality of radially disposed side forming mandrels. Each side blank is wrapped around a respective side forming mandrel and pressed by a respective seam clamp as the turret revolves. After a partial revolution of the turret, the seam adheres and the side blank 52 forms a sleeve. The finished sleeves are removed from the respective side forming mandrels by an indexed-motion sleeve transfer system 28, which comprises a continuously running transfer wheel 62 and a sleeve distributor table 64.

The bottom paper feeding system 30 delivers paper to be processed into container bottoms. The bottom paper enters the bottom forming unit 32, which comprises a single punch-die former. The bottom forming unit 32 punches and draws a bottom blank and transfers the bottom blank up through the bottom transfer table 34 into a respective bottom blank holder defined by the table 34. In one conventional device, the bottom transfer table 34 comprises five bottom blank holders. Each time a single bottom blank is formed and placed in one of the holders, the bottom transfer table 34 indexes a single holder position and advances the bottom blanks toward the container-forming turret 36.

The container-forming turret 36 comprises a plurality of stations, each station comprising a plurality of container forming mandrels. In one arrangement, the container-forming turret comprises eight stations, each having two container forming mandrels. The container-forming turret 36 rotationally indexes the stations so that two container forming mandrels at a time are substantially aligned with respective bottom blanks on the bottom transfer table 34. The bottom blanks are pushed into place on the container forming mandrels and held in place using a vacuum.

The container-forming turret 36 indexes again and the container forming mandrels of one of the stations receive respective sleeves from the indexed-motion sleeve distributor table 64 of the sleeve transfer system 28. The sleeves fit over the bottom blanks in place on the container forming mandrels.

The container-forming turret 36 indexes again and the container forming mandrels of one of the stations are associated with sealing system 38, comprising bottom heaters, bottom in-curl units, and bottom finishing units. The bottom heaters are activated as they engage the sleeve and bottom on the respective container forming mandrels, causing the bottom and the sleeve to seal and form a container. The heaters are deactivated when the mandrels are disengaged.

The container-forming turret 36 indexes again and a container transfer system 40 removes the containers from the container-forming turret. The container transfer system 40 transfers the containers to a top curl system 42, where the finishing treatments are carried out. The finished containers are removed from the device 20 using the container discharge system 44. In one embodiment, the container discharge system comprises a tube under vacuum that pulls the finished containers away from the device to be stacked. Alternatively, the container discharge system can comprise a mechanical arm, spring loading, pressurized air, or a combination thereof.

The conventional device described above operates at a full speed of 330 cycles per minute (cpm) to produce 330 cups per minute. When the device operates at 330 cpm, all of the components of the device operate at full speed, except the container-forming turret 36, which operates at half-speed (165 cpm) and double indexes.

It would be desirable to operate the device at a higher speed to increase production. However, conventional devices have several drawbacks that preclude higher speed operation. First, the conventional side paper feeding systems have been found to limit production. For example, the roll-fed system sometimes requires a manufacturing interruption when the paper rolls are changed. Further, the vertical side blank delivery system is limited to approximately a 10-inch stack of side blanks in a hopper and, therefore, requires nearly constant reloading. The carousel system, which utilizes the same hoppers, also needs frequent reloading. In addition, many hopper-fed systems are prone to jamming.

Other drawbacks of the conventional devices are the speed at which container bottoms are produced, and the indexed motion to transfer sleeves from the sleeve-forming turret to the container-forming turret.

### SUMMARY OF EXEMPLARY ASPECTS

In the following description, certain aspects and embodiments of the present invention will become evident. It should be understood that the invention, in its broadest sense, could be practiced without having one or more features of these aspects and embodiments. It should also be understood that these aspects and embodiments are merely exemplary.

One aspect relates to a device for making containers, comprising a paper feeding system configured to feed side blanks, a sealing activation system configured to receive the side blanks and activate sealing of opposing edges of each side blank so that the opposing edges of the side blank can adhere to each other, a sleeve-forming unit comprising a continuously rotating turret with a plurality of radially disposed mandrels, each side blank being wrapped around a respective mandrel so that activated opposing edges of the side blank contact each other and adhere to each other to form a sleeve, an indexed container-forming turret comprising mandrels and being configured to rotate, a continuously running mechanism to remove sleeves from the mandrels of the sleeve-forming unit and transfer them to the mandrels of the container-forming turret, and a bottom forming unit configured to form bottoms that are fed to the indexed container-forming turret. The indexed container-forming turret adheres the bottoms to the sleeves.

Another aspect relates to a method of making containers, comprising feeding side blanks along a path, receiving the side blanks and activating sealing of opposing edges of each side blank so that the opposing edges of the side blank can adhere to each other, receiving the activated side blanks on a continuously rotating turret with a plurality of radially disposed mandrels, wrapping each side blank around a respective mandrel so that activated opposing edges of the side blank contact each other and adhere to each other to form a sleeve, continuously removing sleeves from the mandrels, forming bottoms that are fed to a container-forming turret, and adhering the bottoms to the sleeves.

Another aspect relates to a device for making containers, comprising means for feeding side blanks along a path, means for receiving the side blanks and activating sealing of opposing edges of each side blank so that the opposing edges of the side blank can adhere to each other, means for forming sleeves, comprising a continuously-rotating turret with a plurality of radially disposed mandrels, each side blank being wrapped around a respective mandrel so that activated opposing edges of the side blank contact each other and adhere to each other to form a sleeve, means for continuously removing sleeves from the mandrels of the continuously-rotating turret and transferring them to a container-forming turret, means for forming bottoms that are fed to the container-forming turret, and means for adhering the bottoms to the sleeves.

Another aspect relates to a device for making containers, comprising a paper feeding system configured to feed side blanks, a sealing activation system configured to receive the side blanks and activate sealing of opposing edges of each side blank so that the opposing edges of the side blank can adhere to each other, a sleeve-forming unit comprising a continuously rotating turret with a plurality of radially disposed mandrels, each side blank being wrapped around a respective mandrel so that activated opposing edges of the side blank contact each other and adhere to each other to form a sleeve, an indexed container-forming turret comprising mandrels and being configured to rotate, a mechanism to remove sleeves from the mandrels of the sleeve-forming unit and transfer them to the mandrels of the container-forming turret, and a bottom forming unit configured to form bottoms that are fed to the indexed container-forming turret. The indexed container-forming turret adheres the bottoms to the sleeves. The side blanks move continuously from the paper feeding system to a sleeve distributor table receiving sleeves directly from the tangential sleeve transfer turret.

Another aspect relates to a device for making containers, comprising a paper feeding system configured to feed side blanks, heaters to activate adhesive strips on the side blanks, a sleeve-forming unit comprising a continuously rotating turret with a plurality of radially disposed mandrels, each side blank being wrapped around a respective mandrel so that activated opposing edges of the side blank contact each other and adhere to each other to form a sleeve, an indexed container-forming turret comprising mandrels and being configured to rotate, a mechanism to remove sleeves from the mandrels of the sleeve-forming unit and transfer them to the mandrels of the container-forming turret, and a bottom forming unit configured to form bottoms that are fed to the indexed container-forming turret. The indexed container-forming turret adheres the bottoms to the sleeves. At least one heater rotates along each side of the paper feeding system.

Another aspect relates to a device for making containers, comprising a paper feeding system configured to feed side blanks, a sealing activation system configured to receive the side blanks and activate sealing of opposing edges of each side blank so that the opposing edges of the side blank can adhere to each other, a sleeve-forming unit comprising a continuously rotating turret with a plurality of radially disposed mandrels, each side blank being wrapped around a respective mandrel so that activated opposing edges of the side blank contact each other and adhere to each other to form a sleeve, an indexed container-forming turret comprising mandrels and being configured to rotate, a mechanism to remove sleeves from the mandrels of the sleeve-forming unit and transfer them to the mandrels of the container-forming turret, and a bottom forming unit configured to form bottoms that are fed to the indexed container-forming turret. The indexed container-forming turret adheres the bottoms to the sleeves. The bottom forming unit comprises at least two bottom formers that form at least two container bottoms substantially simultaneously. A paper ribbon is fed to the bottom formers at an appropriate angle to the bottom formers so that two bottom blanks can be nested in a single ribbon with a width less than that of two separate ribbons.

Another aspect relates to a device for making containers, comprising a paper feeding system configured to feed side blanks, a sleeve-forming unit receiving the slide blanks and forming them into sleeves, a bottom forming unit configured to form bottoms, an indexed container-forming turret for receiving the sleeves and the bottoms and adhering a bottom to each sleeve, and a continuously running mechanism to remove sleeves from the sleeve-forming unit and transfer them to the container-forming turret.

Another aspect relates to a device for making containers, comprising, a paper feeding system configured to feed side blanks, a sleeve-forming unit receiving the slide blanks and forming them into sleeves, a bottom forming unit configured to form bottoms, an indexed container-forming turret for receiving the sleeves and the bottoms and adhering a bottom to each sleeve, and a mechanism to remove sleeves from the sleeve-forming unit and transfer them to the container-forming turret. The bottom forming unit comprises at least two bottom formers that form at least two container bottoms substantially simultaneously. A paper ribbon is fed to the bottom formers at an appropriate angle to the bottom formers so that two bottom blanks can be nested in a single ribbon with a width less than that of two separate ribbons.

Yet another aspect relates to a device for making containers, comprising a paper feeding system configured to feed side blanks, a sleeve-forming unit receiving the slide blanks and forming them into sleeves, a bottom forming unit configured to form bottoms, an indexed container-forming turret for receiving the sleeves and the bottoms and adhering a bottom to each sleeve, and a mechanism to remove sleeves from the sleeve-forming unit and transfer them to the container-forming turret. At least one heater rotates along each side of the paper feeding system to receive the side blanks and activate sealing of adhesive strips on opposing edges of each side blank so that the opposing edges of the side blank can adhere to each other, each heater having at least one heating element and a stationary plate, the heating element being activated where it overlaps the stationary plate, the overlap being in alignment with the adhesive strips of the side blanks.

Aside from the structural and procedural arrangements set forth above, the invention could include a number of other arrangements such as those explained hereinafter. It is to be understood that both the foregoing description and the following description are exemplary only.

### BRIEF DESCRIPTION OF THE DRAWINGS

The accompanying drawings, which are incorporated in and constitute a part of this specification, illustrate several exemplary embodiments of the invention and together with the description, serve to explain the principles of the invention. In the drawings,

FIG. 1 is a schematic view of a conventional device for making containers;

FIG. 2 is a perspective view of a conventional vertical side blank delivery system;

FIG. 3 is a schematic top view of an embodiment of a device for making containers according to the present invention;

FIG. 4 is a schematic side view of an exemplary side blank conveyor of the device of FIG. 3; and

FIG. 5 is a schematic side view of an exemplary bottom forming unit and bottom transfer table of the device of FIG. 3.

FIG. 6 illustrates an exemplary bottom blanking method for the device of FIG. 3.

FIG. 7 is a schematic illustration of the continuously rotating tangential sleeve transfer of an alternative embodiment of a portion of the device of FIG. 3.

FIG. 8 is a schematic illustration of rotating heaters of the device of FIG. 3.

FIG. 9 illustrates a schematic top view of a portion of the device of FIG. 3.

FIG. 10 illustrates a schematic side view of placement of a side blank positioning ramp on the device of FIG. 3.

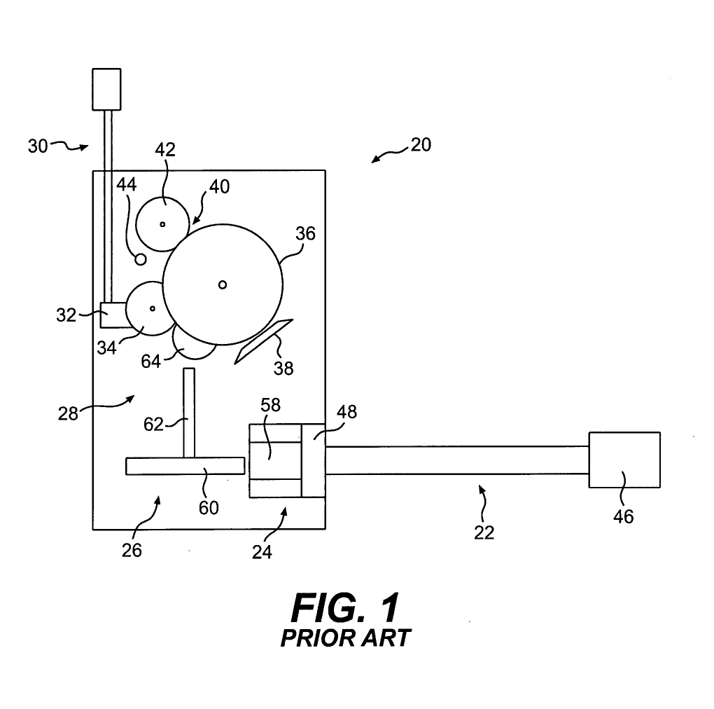

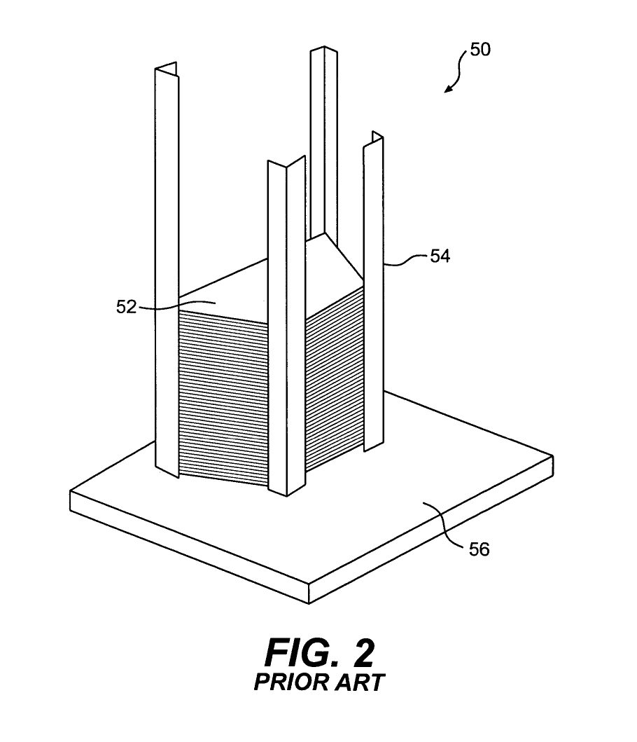

### DETAILED DESCRIPTION OF EXEMPLARY EMBODIMENTS

Reference will now be made in detail to the exemplary embodiments of the invention, examples of which are illustrated in the accompanying drawings. Wherever possible, the same reference numbers will be used throughout the drawings to refer to the same or like parts.

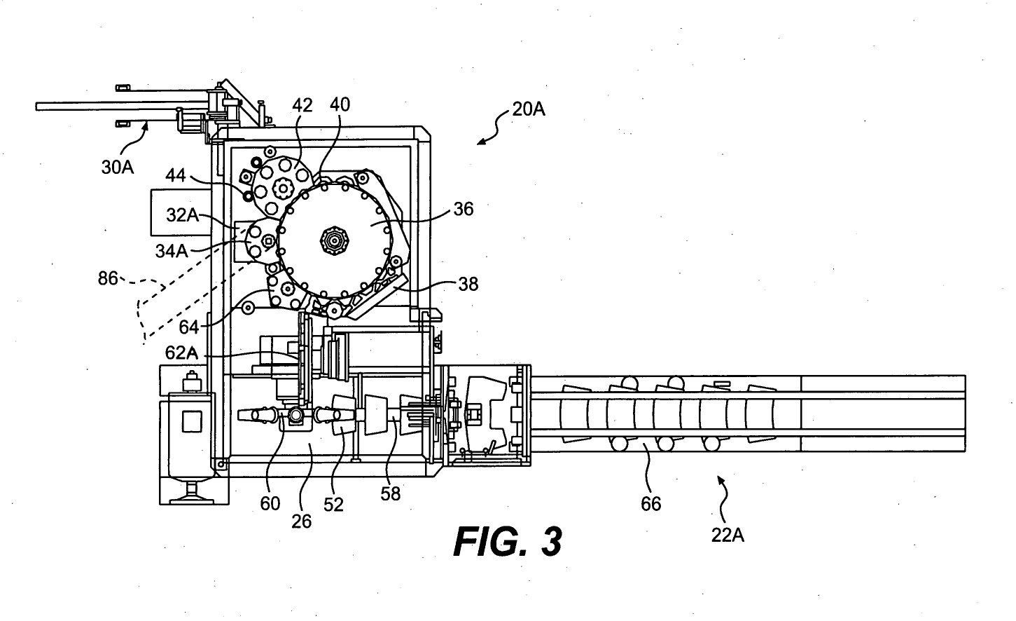

An embodiment of a device 20A is shown in FIG. 3. This device incorporates several systems and components that may allow a container production rate of up to double the rate attained by at least some conventional devices.

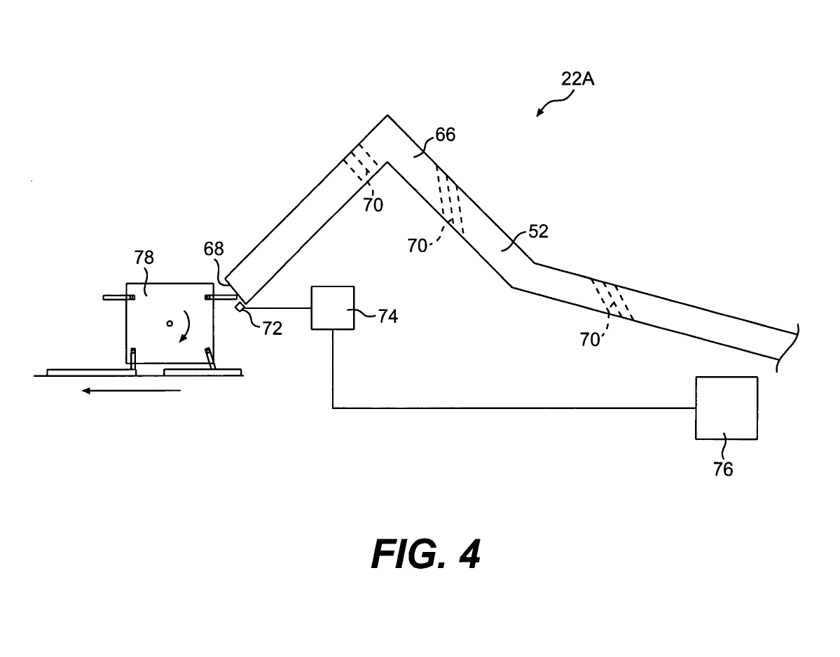

First, the device incorporates a side paper feeding system 22A comprising a conveyor 66 that delivers pre-cut side blanks 52 in an angled stack. An embodiment of the side paper feeding system 22A is shown in FIG. 4. The system 22A comprises a conveyor 66 having an open top. Pre-cut side blanks 52 are supported on the large radius edge of the blanks on the conveyor 66 in an angled orientation. As the side blanks 52 are moved to the unloading position 68, they form a stack. The lines 70 in FIG. 4 represent the orientation of the side blanks 52 on the different sections of the conveyor 66. The motion of the conveyor 66 is continuous, while delivery of the pre-cut side blanks is indexed. As a result, there is a gap between pre-cut side blanks 52 as they move along the continuous conveyor 66.

In this embodiment, the side paper feeding system 22A is provided with a pressure sensor 72 at the bottom of the stack of side blanks 52 in the unloading position 68. The pressure sensor 72 is connected to a controller 74 for the conveyor motor 76. This feedback control loop adjusts the conveyor speed to maintain the stack of blanks 52 at a height that produces a constant pressure on the bottom blank. The maintenance of pressure on the bottom blank facilitates the extraction of the bottom blank. The extraction is carried out with an unloading device 78, such as, for example, a pick-and-place device shown in FIG. 4.

The side paper feeding system could have any configuration known in the art. Unlike at least some conventional systems, the system 22A shown in FIGS. 3 and 4, maintains the large radius edges of the pre-cut side blanks oriented so that those edges face toward the sleeve-forming unit 26 as the blanks 52 are moved from the stack to the sleeve-forming unit 26. Moreover, the side blanks 52 are delivered in a substantially predictable path (so that the heating elements can be properly aligned) from the unloading device 78 through the side seam heating system 24 to the sleeve-forming unit 26.

The pre-cut side blanks 52 enter a sealing system, such as a side seam heating system 24. In one example, the side seam heating system 24 may comprise heaters arranged above and below the conveyor to heat the side blanks 52. As a side blank 52 passes adjacent to a heater, the respective heater may be operated to expose the edges of the side blank 52 to a burst of hot air. The hot air activates a coating on the paper that is capable of providing subsequent sealing. The heater may alternatively be continuously operated.

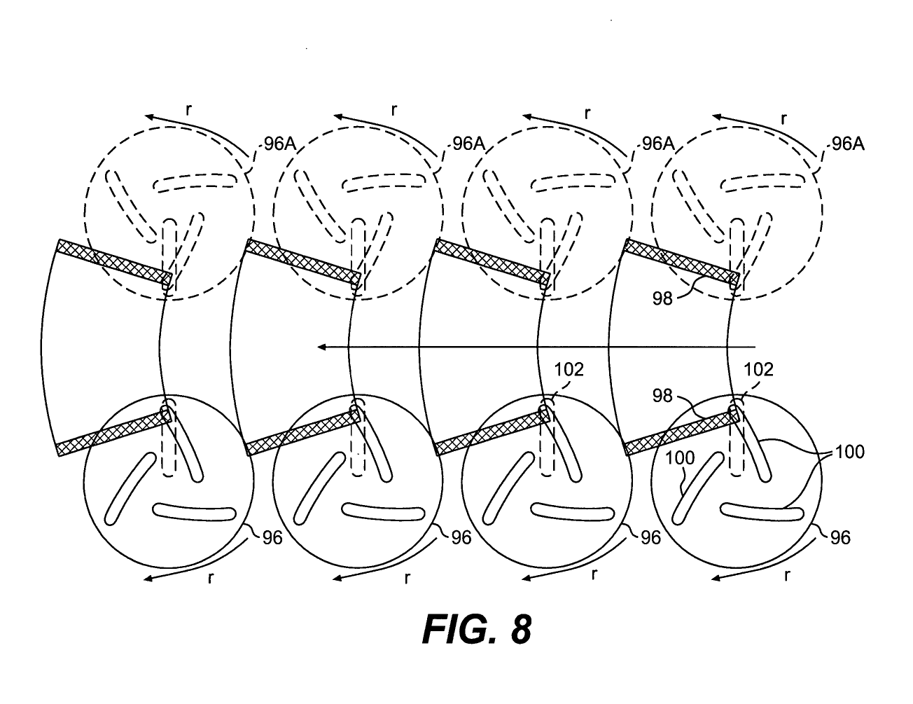

In an exemplary embodiment illustrated in FIGS. 3 and 8, at least one heater 96, 96A is located on each side of the blanks 52 fed by the conveyor 66. The heaters 96, 96A rotate about their central axes with multiple heating elements 100 that selectively activate heating strips 98, 98A on the side of each blank 52. One adhesive strip 98 is located on one side of the blank 52, and the other adhesive strip 98A is located on the other side of the blank 52. Each heater 96 has heating elements 100 located on its underside and lies above one side of each blank 52 to activate adhesive strip 98, and each heater 96A has heating elements 100 on its top side and lies below the blank 52 to activate adhesive strip 98A.

Because the blanks 52 are pre-cut to define frusto-conical sleeves, adhesive strips 98, 98A of the blank 52 are angled along the length of each blank. The heaters 96, 96A heat the adhesive strips 98, 98A at different radial points along the heater 96, 96A. To accomplish this, the heaters 96, 96A have elongated heating elements 100 that extend somewhat radially on the heaters 96, 96A. When blanks 52 are conveyed in a direction D, the heaters 96 are above the blanks 52 and stationary plates 102 are below the heaters 96, while the heaters 96A are below the blanks 52 and the stationary plates 102A are above the blanks 52. During rotation of the heaters 96, 96A in a direction r, each heating element 100 on the rotating heaters 96, 96A becomes aligned with a respective stationary plate 102, and the heating element 100 is activated so as to heat the adhesive strip 98, 98A when the heating element 100 overlaps the stationary plate 102. Overlap of the sections of the heating elements 100 with the stationary plate 102 is calibrated so that, as the heaters 96, 96A rotate, the heating elements 100 overlap the stationary plate 102 in alignment with adhesive strips 98, 98A of the blank 52.

There are numerous alternative arrangements that could be used to activate sealing of blanks. For example, rather than having circular heaters, other heaters may be used that can track the tapered shape of the blanks 52 and the resulting placement of their adhesive strips 98, 98A.

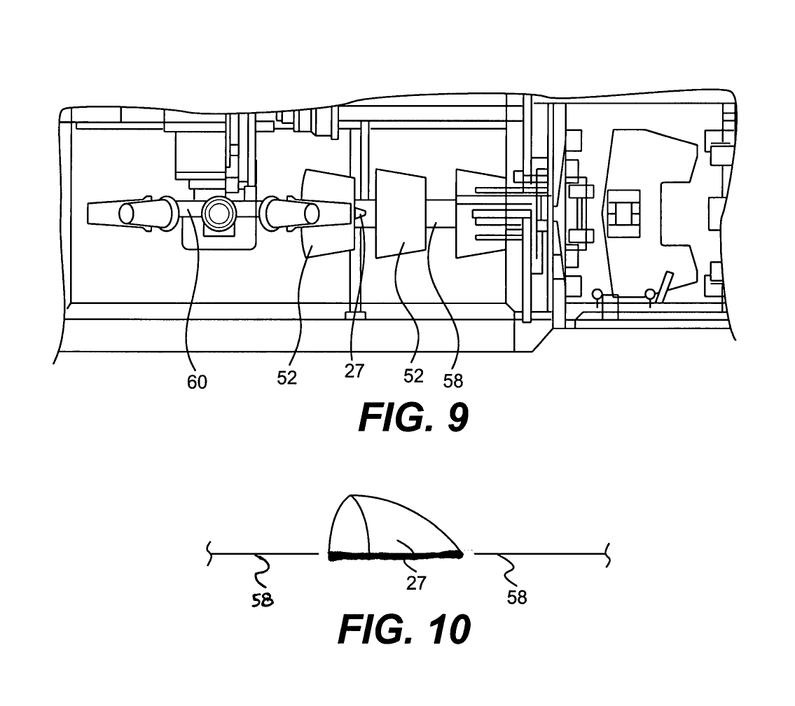

The heated pre-cut side blanks 52 next enter the sleeve-forming unit 26 at a high rate of speed. The forward-moving blanks may be halted temporarily in the correct position upon entry into the sleeve-forming unit 26. To avoid the blanks 52 bouncing back after being stopped from such a high rate of speed, one or more ramps 27 (see FIGS. 9 and 10) or the like may be provided to temporarily halt movement of the blanks 52 while limiting or preventing bounce back of the blanks 52. The ramps 27 are positioned between sections of a conveyor belt 58 and at a point along the conveyor 58 so that they stop the blank in an appropriate position for the sleeve-forming unit 26.

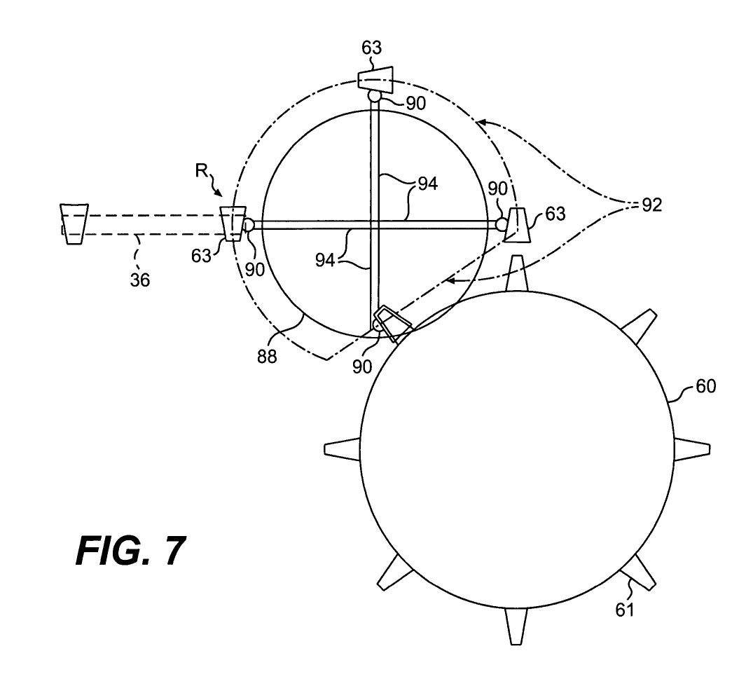

The sleeve-forming unit 26 comprises a continuously rotating turret 60 having a plurality of radially disposed side-forming mandrels 61 (see FIG. 7). (As used herein, “continuously” means continuous motion (as opposed to indexed motion) that is free from periodic starting and stopping during operation of the device to produce containers. In some examples having at least components that are continuously moving may allow a device to run at a faster speed and incur less wear and tear.) Each side blank is wrapped around a respective mandrel 61 (FIG. 7) and pressed by a respective seam clamp (not shown) as the turret 60 revolves. After a partial revolution of the turret, the seam adheres and the side blank 52 forms a sleeve 63. In an exemplary embodiment, the sleeves 63 are removed from the respective mandrels 61 on the continuously rotating turret 60 by a continuously running mechanism 62A, such as a tangential sleeve transfer 88 as described below and shown in FIG. 7.

In an exemplary embodiment, the tangential sleeve transfer 88 is a turret with four stations, although it may have any number of stations. Each station has a vacuum-driven suction cup 90 or other coupling means to adhere to a sleeve 63 on a mandrel 61 as it is rotated on the turret 60. Upon adhering to the sleeve 63, the suction cup 90 removes the sleeve 63 from the mandrel 61 along a sleeve path 92 shown as a broken line in FIG. 7. To move the sleeves 63 along sleeve path 92, the tangential sleeve transfer 88 includes arms 94, wherein a respective suction cup 90 or other adherent is at an end of each arm 94. The arms 94 are driven along the sleeve path 92, which is not entirely circular but rather extends tangential to the turret 60 as the sleeve is removed from the turret by a cammed track (not shown) that moves the arms 94 radially inward and outward to trace the desired sleeve path.

At position R in FIG. 7, the tangential sleeve transfer 88 releases the vacuum suction or other adherence to the sleeve 63 so that sleeve 63 is deposited into a receiver in the indexed sleeve distributor table 64 (shown in FIG. 3). The sleeve distributor table 64 distributes the sleeve to the indexed container-forming turret 36. In this exemplary embodiment, movement of the blanks in the container-making device is continuous from the provision of the pre-cut side blanks to the indexed sleeve distributor table 64.

In addition, the device in FIG. 3 utilizes a bottom paper feeding system 30A and a bottom forming unit 32A that are configured to produce and deliver two container bottoms substantially simultaneously. Although the embodiment shown in the drawings is configured to produce and deliver two container bottoms simultaneously, it should be appreciated that alternative embodiments could be configured to produce and deliver more than two bottoms substantially simultaneously.

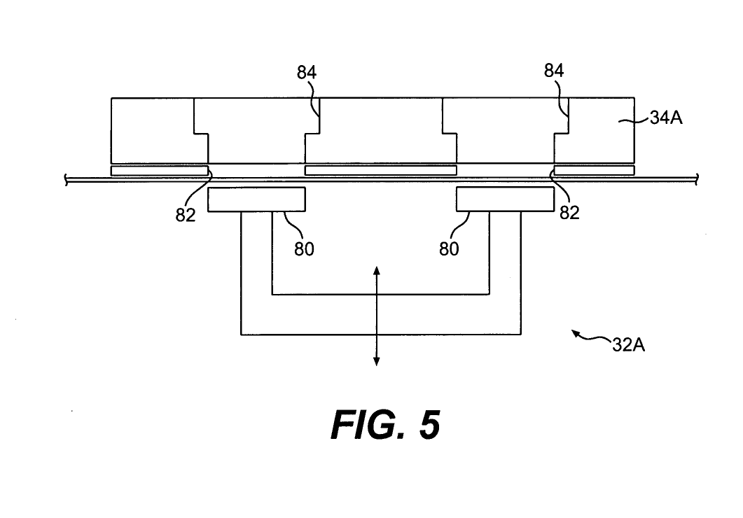

The bottom forming unit 32A comprises at least two bottom formers (e.g., punches and/or dies) that operate substantially simultaneously to form at least two container bottoms substantially simultaneously. An example of the bottom forming unit 32A is shown in FIG. 5. The direction of motion of punches 80 of the unit 32A is indicated with an arrow. The bottom paper feeding system 30A supplies bottom paper to the bottom forming unit 32A and advances the paper into the bottom forming unit 32A a sufficient distance to allow the punches 80 to cut bottom blanks from the paper substantially simultaneously. The cut blanks are subsequently drawn through dies 82 and transferred to bottom blank holders 84 of a bottom transfer table 34A. The bottom transfer table 34A in this embodiment has four bottom blank holders 84 (situated as partially shown in FIG. 3), but other arrangements are possible. In operation, the bottom transfer table 34A is indexed (e.g., rotated 180°) so that while two bottom holders 84 are being loaded, the other two are delivering container bottoms to respective mandrels on the container-forming turret 36. In the embodiment of FIG. 3, the container-forming turret 36 is shown to have sixteen stations.

In one embodiment, a bottom transfer table 34A may be omitted if the upward movement of the punches 80 extends through the dies 82 to deliver the blanks to their proper position on the container-forming turret 36.

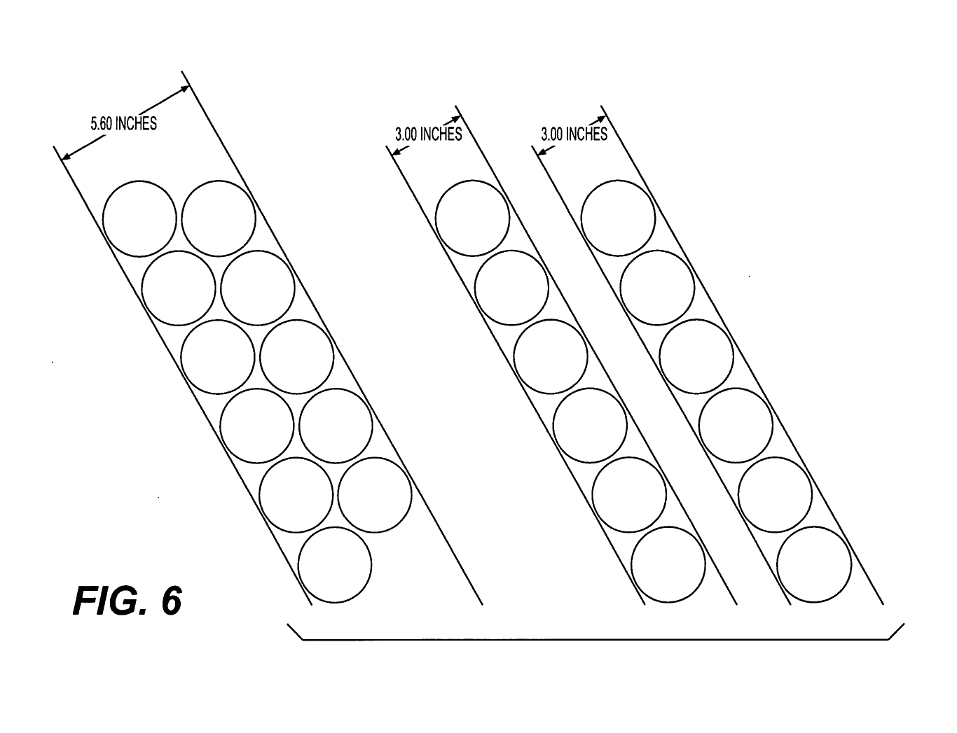

In one embodiment, the bottom forming unit 32A can blank two bottoms from a single ribbon of paper supplied by the bottom paper feeding system 30A. Such a unit may save paper because the blanks can be nested in a single ribbon with a width less than that of two separate ribbons. Nesting of the blanks and the paper savings is illustrated in FIG. 6, which illustrates that a single 5.6 inch ribbon of paper replaces two 3.0 inch ribbons when the blanks are nested. In this embodiment, the punches 80 illustrated in FIG. 5 are slightly offset (the punches 80 are at different positions along the direction of travel of the bottom blank ribbon 86.). Alternatively, the paper ribbon 86 may be fed to the bottom forming unit 32A at an appropriate angle from 0° to 45° so that the two blanks can be cut from a single ribbon while minimizing waste.

In one embodiment, the device 20A is operated at a speed of about 660 cpm. Thus, all of the components may be operated at about 660 cpm, except for the bottom transfer table 34A and the container-forming turret 36, which may operate at half-speed (i.e., 330 cpm). The bottom transfer table 34A and the container-forming turret 36 may operate at half-speed because these units may double index and carry out twice the production steps in a single movement.

It will be apparent to those skilled in the art that various modifications and variations can be made to the structure and methodology described herein. Thus, it should be understood that the invention is not limited to the examples discussed in the specification. Rather, the present invention is intended to cover modifications and variations.

1. A device for making containers, comprising:
a paper feeding system configured to feed side blanks;
a sealing activation system configured to receive the side blanks and activate sealing of opposing edges of each side blank so that the opposing edges of the side blank can adhere to each other;
a sleeve-forming unit comprising a continuously rotating turret with a plurality of radially disposed mandrels, each side blank being wrapped around a respective mandrel so that activated opposing edges of the side blank contact each other and adhere to each other to form a sleeve;
an indexed container-forming turret comprising mandrels and being configured to rotate;
a continuously running mechanism to remove sleeves from the mandrels of the sleeve-forming unit and transfer them to the mandrels of the container-forming turret; and
a bottom forming unit configured to form bottoms that are fed to the indexed container-forming turret;
wherein the indexed container-forming turret adheres the bottoms to the sleeves.

2. The device of claim 1, wherein the continuously running mechanism is a tangential sleeve transfer turret.

3. The device of claim 2, wherein the container-making device is configured so that the side blanks move continuously from the paper feeding system to a sleeve distributor table receiving sleeves directly from the tangential sleeve transfer turret.

4. The device of claim 1, wherein the sealing activation system includes heaters that activate adhesive strips on the side blanks.

5. The device of claim 4, wherein the heaters are circular and at least one heater rotates along each side of the paper feeding system.

6. The device of claim 5, wherein each heater has at least one heating element and a stationary plate, the heating element being activated where it overlaps the stationary plate.

7 The device of claim 6, wherein the heater is configured so that, as it rotates, the heating elements overlaps the stationary plate in alignment with adhesive strips of the side blanks.

8. The device of claim 2, wherein the tangential sleeve transfer unit comprises multiple stations, each station being configured to adhere to a sleeve on the sleeve-forming unit.

9. The device of claim 8, wherein each station comprises a suction cup.

10. The device of claim 2, wherein the tangential sleeve transfer turret conveys sleeves removed from the sleeve-forming unit along a sleeve path that is non-circular and that extends tangential to the sleeve-forming unit as the sleeve is removed from the sleeve-forming unit.

11. The device of claim 10, wherein the tangential sleeve transfer turret comprises a cammed track that drives sleeves along the sleeve path.

12. The device of claim 1, wherein the bottom forming unit comprises at least two bottom formers that form at least two container bottoms substantially simultaneously, and wherein a paper ribbon is fed to the bottom formers at an appropriate angle to the bottom formers so that two bottom blanks can be nested in a single ribbon with a width less than that of two separate ribbons.

13. The device of claim 1, wherein a section of conveyor extends between the sealing activation system and the sleeve-forming unit, the section of conveyor including a ramp that allows side blanks to pass in only one direction from the sealing activation system to the sleeve-forming unit, and holds the blanks in an appropriate position for the sleeve-forming unit.

14. The device of claim 1, wherein the paper feeding system comprises a conveyor supporting side blanks on a large radius edge of the blanks and moving the side blanks to an unloading position where they are unloaded to form a stack having a bottom, and an unloading device extracting side blanks from the bottom of the stack and delivering the side blanks to the sealing activation system.

15. A method of making containers, comprising:
feeding side blanks along a path;
receiving the side blanks and activating sealing of opposing edges of each side blank so that the opposing edges of the side blank can adhere to each other;
receiving the activated side blanks on a continuously rotating turret with a plurality of radially disposed mandrels;
wrapping each side blank around a respective mandrel so that activated opposing edges of the side blank contact each other and adhere to each other to form a sleeve;
continuously removing sleeves from the mandrels;
forming bottoms that are fed to a container-forming turret; and
adhering the bottoms to the sleeves.

16. A device for making containers, comprising:
means for feeding side blanks along a path;
means for receiving the side blanks and activating sealing of opposing edges of each side blank so that the opposing edges of the side blank can adhere to each other;
means for forming sleeves, comprising a continuously-rotating turret with a plurality of radially disposed mandrels, each side blank being wrapped around a respective mandrel so that activated opposing edges of the side blank contact each other and adhere to each other to form a sleeve;
means for continuously removing sleeves from the mandrels of the continuously-rotating turret and transferring them to a container-forming turret;
means for forming bottoms that are fed to the container-forming turret; and
means for adhering the bottoms to the sleeves.

17. A device for making containers, comprising:
a paper feeding system configured to feed side blanks;
a sealing activation system configured to receive the side blanks and activate sealing of opposing edges of each side blank so that the opposing edges of the side blank can adhere to each other;
a sleeve-forming unit comprising a continuously rotating turret with a plurality of radially disposed mandrels, each side blank being wrapped around a respective mandrel so that activated opposing edges of the side blank contact each other and adhere to each other to form a sleeve;
an indexed container-forming turret comprising mandrels and being configured to rotate;
a mechanism to remove sleeves from the mandrels of the sleeve-forming unit and transfer them to the mandrels of the container-forming turret; and
a bottom forming unit configured to form bottoms that are fed to the indexed container-forming turret;
wherein the indexed container-forming turret adheres the bottoms to the sleeves; and
wherein the side blanks move continuously from the paper feeding system to a sleeve distributor table receiving sleeves directly from the tangential sleeve transfer turret.

18. A device for making containers, comprising:
a paper feeding system configured to feed side blanks;
heaters to activate adhesive strips on the side blanks;
a sleeve-forming unit comprising a continuously rotating turret with a plurality of radially disposed mandrels, each side blank being wrapped around a respective mandrel so that activated opposing edges of the side blank contact each other and adhere to each other to form a sleeve;
an indexed container-forming turret comprising mandrels and being configured to rotate;
a mechanism to remove sleeves from the mandrels of the sleeve-forming unit and transfer them to the mandrels of the container-forming turret; and
a bottom forming unit configured to form bottoms that are fed to the indexed container-forming turret;
wherein the indexed container-forming turret adheres the bottoms to the sleeves; and
wherein at least one heater rotates along each side of the paper feeding system.

19. The device of claim 18, wherein each heater has at least one heating element and a stationary plate, the heating element being activated where it overlaps the stationary plate, the overlap being in alignment with adhesive strips of the side blanks.

20. A device for making containers, comprising:
a paper feeding system configured to feed side blanks;
a sealing activation system configured to receive the side blanks and activate sealing of opposing edges of each side blank so that the opposing edges of the side blank can adhere to each other;
a sleeve-forming unit comprising a continuously rotating turret with a plurality of radially disposed mandrels, each side blank being wrapped around a respective mandrel so that activated opposing edges of the side blank contact each other and adhere to each other to form a sleeve;
an indexed container-forming turret comprising mandrels and being configured to rotate;
a mechanism to remove sleeves from the mandrels of the sleeve-forming unit and transfer them to the mandrels of the container-forming turret; and
a bottom forming unit configured to form bottoms that are fed to the indexed container-forming turret;
wherein the indexed container-forming turret adheres the bottoms to the sleeves; and
wherein the bottom forming unit comprises at least two bottom formers that form at least two container bottoms substantially simultaneously, and wherein a paper ribbon is fed to the bottom formers at an appropriate angle to the bottom formers so that two bottom blanks can be nested in a single ribbon with a width less than that of two separate ribbons.

21. A device for making containers, comprising:
a paper feeding system configured to feed side blanks;
a sleeve-forming unit receiving the slide blanks and forming them into sleeves;
a bottom forming unit configured to form bottoms;
an indexed container-forming turret for receiving the sleeves and the bottoms and adhering a bottom to each sleeve; and
a continuously running mechanism to remove sleeves from the sleeve-forming unit and transfer them to the container-forming turret.

22. A device for making containers, comprising:
a paper feeding system configured to feed side blanks;
a sleeve-forming unit receiving the slide blanks and forming them into sleeves;
a bottom forming unit configured to form bottoms;
an indexed container-forming turret for receiving the sleeves and the bottoms and adhering a bottom to each sleeve; and
a mechanism to remove sleeves from the sleeve-forming unit and transfer them to the container-forming turret;
wherein the bottom forming unit comprises at least two bottom formers that form at least two container bottoms substantially simultaneously, and wherein a paper ribbon is fed to the bottom formers at an appropriate angle to the bottom formers so that two bottom blanks can be nested in a single ribbon with a width less than that of two separate ribbons.

23. A device for making containers, comprising:
a paper feeding system configured to feed side blanks;
a sleeve-forming unit receiving the slide blanks and forming them into sleeves;
a bottom forming unit configured to form bottoms;
an indexed container-forming turret for receiving the sleeves and the bottoms and adhering a bottom to each sleeve; and
a mechanism to remove sleeves from the sleeve-forming unit and transfer them to the container-forming turret;
wherein at least one heater rotates along each side of the paper feeding system to receive the side blanks and activate sealing of adhesive strips on opposing edges of each side blank so that the opposing edges of the side blank can adhere to each other, each heater having at least one heating element and a stationary plate, the heating element being activated where it overlaps the stationary plate, the overlap being in alignment with the adhesive strips of the side blanks.
